(19) United States
(12) Patent Application Publication
(10) Pub. No.: US 2011/0016130 A1
(43) Pub. Date: Jan. 20, 2011

(54) Method and an apparatus for providing at least one configuration data ontology module

(75) Inventors: Pinar Wennerberg, Munich (DE); Sonja Zillner, Munich (DE)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft, Munich (DE)

(21) Appl. No.: 12/585,955

(22) Filed: Sep. 29, 2009

(30) Foreign Application Priority Data
Jul. 20, 2009 (EP) EP09009391

(51) Int. Cl. G06F 17/30

(52) U.S. Cl. 707/738; 707/E17.099

(57) ABSTRACT

A method and an apparatus provide at least one configuration data ontology module. Modules are extracted from an ontology under consideration of the semantics of the ontology. Therefore, individual concepts are selected from the ontology which are in a subsequent step connected by relations. The method and apparatus are used in ontology modularization, and especially in biomedical application domains.

### CROSS REFERENCE TO RELATED APPLICATIONS

This application is based on and hereby claims priority to EP Application No. EP09009391 filed on Jul. 20, 2009, the contents of which are hereby incorporated by reference.

### BACKGROUND OF THE INVENTION

The invention relates to a method and an apparatus for partitioning of ontologies and especially to providing at least one configuration data ontology module.

Formal knowledge about human anatomy, radiology or diseases is necessary to support clinical applications such as medical image search. This machine processable knowledge can be acquired from biomedical domain ontologies, which however, are typically very large and complex models. Thus, their straightforward incorporation into the software applications becomes difficult.

Especially in the healthcare sector a variety of semantic knowledge resources is established. Such semantic knowledge sources model domain specific knowledge by, for instance, semantic resources. A semantic resource may comprise be in form of a taxonomy, a thesaurus, semantic net and/or an ontology. Furthermore documents and/or sets of notions may be sources of domain specific information. A taxonomy may model domain specific knowledge by nodes and edges. Nodes, which are labeled, hereby represent domain specific concepts. Edges establish a hierarchy of the introduced concepts. Such a hierarchy can reflect class-subclass relationships. A thesaurus and/or a semantic net may furthermore introduce richer edge semantics. For instance an edge between two concepts may indicate a synonymy relation. Edges may also be freely typed by the author of the knowledge source. A semantic net can also be called a lightweight ontology. Furthermore heavyweight ontologies may be used to enable the author to assign richer semantics and/or constraints to node and/or edge semantics.

In commonly known approaches ontology modularization is realized by automatically or user-driven methods, but in both cases the modularization of the ontology is a challenging task. For example, ontology modularization approaches that guarantee logical consistency may deliver too large fragments and can be slow in performance. On the other hand graph-based approaches are more efficient but they do not guarantee the logical completeness. Finally, manually created ontology fragments to naturally have the required level of granularity but they are expensive in terms of time and resources and are open to human errors.

### SUMMARY

It is therefore one potential object of the present invention to provide a method, which automatically generates modules of ontologies which are fine grained and provide reliable information.

The inventors propose a method for providing at least one configuration data ontology module, which provides configuration data for at least one machine and comprises the following steps:

In a first step selecting a first concept and a second concept from a stored configuration data ontology as a function of assigned concept weights is accomplished. The stored configuration data ontology comprises a set of related concepts. Each related concept having an assigned concept weight.

In a further step generating the configuration data ontology module is accomplished by automatically establishing a relation between the first selected concept and the second selected concept, wherein the first selected concept and the second selected concept are related to a third concept being comprised in the stored configuration data ontology.

A stored configuration data ontology provides information for a machine, which is necessary to operate the machine. The machine may be required for instance for flexible medical image processing applications. For operating such machines efficiently large data amounts, such as a stored configuration data ontology have to be modularized into smaller manageable parts. The stored configuration data ontology may for instance be formed by Foundational Model of Anatomy, also referred to as FMA ontology. The FMA ontology provides a plurality of anatomical concepts and relations between the concepts. The relations are modelled according to several types of relation, such as “is-a” or “part-of” type.

The concepts of the stored configuration data ontology are weighted, which means that each concept of the stored configuration data ontology is assigned a weight indicating a relevance, a reliability or a value according to other metrics. Selecting the first concept and the second concept may furthermore comprise sub-steps such as generating the concept weights. For generating the concept weights the person skilled in the art may refer to commonly known methods. Concepts being comprised in the configuration data ontology are related in case a relation is modelled between the pairwised concepts. Also further metrics may be applied for identifying related concepts. Especially, linguistic and/or statistical approaches may be suitable for identification of related concepts.

For generating the configuration data ontology module a further relation between the first selected concept and the second selected concept is automatically established. Hence, the first selected concept and the second selected concept form a configuration data ontology module. For a selection of the first concept and the second concept the assigned concept weights are compared. The comparison identifies concepts holding the same assigned concept weights or identifies concepts holding a concept weight being above a prescribed threshold. Relations between the first selected concept and the second selected concept are only established in case the first selected concept and the second selected concept are related to a third concept. The third concept is comprised in the stored configuration data ontology, without a necessity of being selected. This means that the third concept is not necessarily part of the configuration data ontology module.

For determining if the first selected concept and the second selected concept are related to the third concept several metrics can be applied. It may be the case that only direct relations between the first selected concept and the third concept as well as a direct relation between the second selected concept and the third concept are considered for determining relatedness.

It may be of advantage to define that not only direct relatedness between concepts is considered but to define the number of intermediate concepts, which do not harm the feature that two concepts are indirectly related. In case a path exists between the first selected concept and the third concept as well as a path between the second selected concept and the third concept that further concepts lie on the path. Hence, a threshold is required to determine how long a path between concepts may be, to still consider the pairwise concepts as being related.

The threshold for describing relatedness may for instance comprise the calculation of a number of a maximum of intermediate nodes on a path between two concepts. Hence, also indirect relatedness between concepts can be considered in the present method. One may for instance define that two concepts are related to a third concept if they are related indirectly by a maximum number of five intermediate concepts.

The threshold for determining relatedness may be defined as a function of a further text corpus. If a configuration data ontology is of large extent, one may define, that relatedness is also given in case a path between two concepts is longer than five nodes. Typically, at a value of ten intermediate concepts two selected pairwise concepts are not related. Hence, the threshold for relatedness of concepts may for instance be defined as a number between five and ten. Accordingly, one may define that only relations of the same type or direction are considered in determining the relatedness of concepts. Hence, it may be of advantage to consider only relations of the same type for estimating relatedness of pairwise concepts.

In an embodiment of the method, selecting the first concept and the second concept as performed as a function of a weight threshold.

This provides the advantage, that selecting the first concept and the second concept can be performed under consideration of a threshold, the threshold further considering the application scenario. Hence, by the threshold selecting the first concept and the second concept can be adapted to any applications scenario.

In an embodiment of the method, the weight threshold defines a lower limit for assigned concept weights of the first concept and of the second concept.

This provides the advantage, that only concepts are considered holding a concept weight above the prescribed threshold.

In an embodiment of the method, the weight threshold is selected from a group of weight thresholds, the group of weight thresholds comprising:
an absolute weight threshold being defined as a function of the number of concepts of at least one ontology, a weight threshold being defined as a function of the number of concepts of an ontology module and a weight threshold being defined as a function of the number of words of at least one text corpus.

This has the advantage, that the weight threshold can be selected from a variety of types of thresholds responding to the specific application scenario.

In an embodiment of the method, the related concepts being comprised and the configuration data ontology are related by at least one of the group of relation categories, the group of relation categories comprising:
a directed relation,
an undirected relation,
a relation of a prescribed type and
a relation indication a hierarchy.

This provides the advantage, that pairwise concepts may be related by several types of relations.

In an embodiment of the method, the first concept and the second concept are related to the third concept if a first relation between the first concept and a third concept and a second relation between the second concept and the third concept are of the same relation category.

This holds the advantage, that only relation categories, which are equal are considered for determining relatedness of concepts.

In an embodiment of a method, the first relation and the second relation comprises at least one intermediate concept.

This holds the advantage, that not only direct relatedness is considered, but also indirect relatedness over several concepts can be considered.

In an embodiment of the method, an upper limit of intermediate concepts is defined under which pairwise concepts are related.

This has the advantage, that if a path between two concepts is too long, relatedness can be denied.

In an embodiment of the method, a machine is formed by at least one of the group of devices, the group of devices comprising:
a medical device,
a production device,
a data processing system and
an image processing device.

This has the advantage, that the machine can be formed by a variety of other devices, parts or systems.

In an embodiment of the method, the concept is formed by at least one of a group of data elements, the group of data elements comprising:
a term,
an attribute,
a variable,
a value and
a keyword.

This holds the advantage, that a concept can be formed by several data elements, which makes the method and device applicable in a plurality of domains.

The inventors furthermore propose an apparatus for provision of at least one configuration data ontology module, especially for performing at least one of the mentioned methods. The apparatus comprises:
a device for selecting a first concept and a second concept from a configuration data ontology being stored in a storage device as a function of assigned concept weights, the stored configuration data ontology comprising a set of related concepts each related concept having an assigned concept weight.

The apparatus furthermore comprises a device for generating the configuration data ontology module by establishing a relation between the first selected concept and the second selected concept, wherein the first selected concept and the second selected concept are related to a third concept being comprises in the stored configuration data ontology.

The inventors furthermore propose a computer for provision of at least one configuration data ontology module, especially for performing one of the mentioned methods. The computer comprises:
a first calculation device for selection of a first concept and a second concept from a configuration data ontology being stored in a storage device as a function of assigned concept weights. The stored configuration data ontology comprises a set of related concepts each related concept having an assigned concept weight.

The computer furthermore comprises a second calculation device for generation of the configuration data ontology module by establishing a relation between the first selected concept and the second selected concept, wherein the first selected concept and the second selected concept are related to a third concept being comprised in the stored configuration data ontology.

In an embodiment of the computer, the first calculation device and the second calculation device are formed by a single calculation device.

This provides the advantage, that a flexible way to implement the computer is provided.

A computer-readable storage medium stores a program adapted to perform at least one of the effort mentioned methods of a computer.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a schematic illustration of a provision of at least one configuration data ontology module according to an aspect of the inventor's proposals;

FIG. 2 shows a flow diagram of a method for providing at least one configuration data ontology module according to an aspect of the inventor's proposals;

FIG. 3 shows a detailed flow diagram of a method for providing at least one configuration data ontology module according to an aspect of the inventor's proposals;

FIG. 4 shows a block diagram of an apparatus for provision of at least one configuration data ontology module according to an aspect of the inventor's proposals;

FIG. 5 shows a detailed block diagram of an apparatus for provision of at least one configuration data ontology module according to an aspect of the inventor's proposals;

FIG. 6 shows a table of concept weights as being used by a method for providing at least one configuration data ontology module according to an aspect of the inventor's proposals;

FIG. 7 shows a schematic illustration of a hierarchical context of a concept as being used by a method for providing at least one configuration data ontology module according to an aspect of the inventor's proposals;

FIG. 8 shows a schematic illustration of a hierarchical context of a concept as being used by a method for providing at least one configuration data ontology module according to an aspect of the inventor's proposals; and

FIG. 9 shows a schematic illustration of a hierarchical context of a concept as being used by a method for providing at least one configuration data ontology module according to an aspect of the inventor's proposals.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

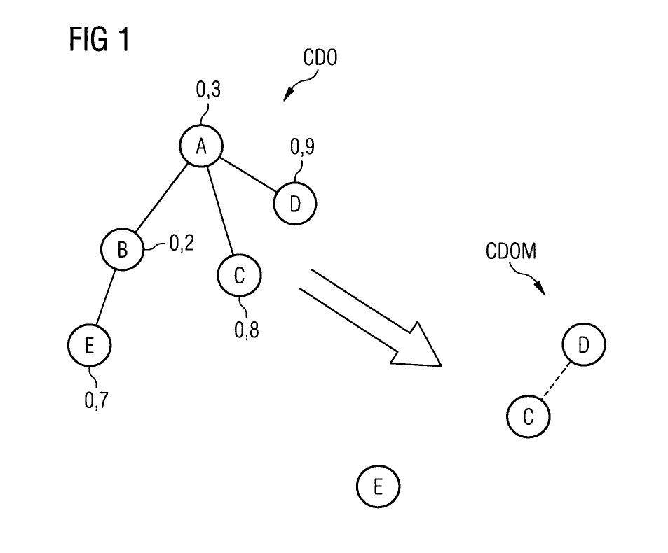

FIG. 1 shows a configuration data ontology CDO from which a configuration data ontology module CDOM is selected according to a method for providing at least one configuration data ontology module CDOM.

In the schematic illustration being depicted in FIG. 1 the configuration data ontology CDO as well as the configuration data ontology module CDOM is represented by nodes and edges. The configuration data ontology CDO provides five nodes, namely nodes A, B, C, D and E. Each of the nodes A, B, C, D and E has one weight assigned. Furthermore, pairwise nodes are related by relations. For instance, one relation connects node B and E. Nodes E and A are indirectly related by an intermediate node B. In the embodiment illustrated in FIG. 1 the nodes A and E are not related, as in the present embodiment demonstrated in FIG. 1 only direct relations are considered. As nodes A and E are only indirectly related over the intermediate node B, they will not be considered as being related in further steps of the method for providing at least one configuration data ontology module CDOM.

The representation of the configuration data ontology CDO as well as the configuration data ontology module CDOM by nodes and edges is only one possible representation out of several other possibilities to represent the ontologies CDO, CDOM. The person skilled in the art appreciates the representation possibilities of the ontologies CDO, CDOM for instance by applying an XML-based format. The ontologies CDO, CDOM may for instance be modelled by RDF(S) or by further representation formats.

In the present embodiment as being demonstrated in FIG. 1 each concept A, B, C, D and E is assigned one concept weight, namely the concept weight 0.2 is for instance assigned to concept B. The concept weight 0.9 is for instance assigned to concept D. In the present embodiment each concept A, B, C, D and E represents one keyword being selected from a given text corpus. In preliminary steps the number of occurrence of each of the concepts A, B, C, D and E in the text corpus have been counted and have furthermore been weighted. Hence, in the present embodiment the keyword modelled by concept D occurred at a specific weight of 0.9 in the text corpus. The keyword being modelled by concept A does occur not as often as concept D in the text corpus. Hence, concept A is assigned only a concept weight of 0.3. In preliminary steps the relations relating pair-wise concepts A, B, C, D and E have been inserted into the configuration data ontology CDO.

Selecting a first concept and a second concept from the stored configuration data ontology CDO performed as a function of the assigned concept weights. For selecting the concepts several metrics may be applied. For instance, one may define a threshold which may for instance be 0.5. Hence, only concepts having a concept weight which exceeds the threshold of 0.5 are selected. The threshold may for instance be defined as a function of the extent of the text corpus, in which the concepts A, B, C, D and E are comprised. The threshold may for instance be an absolute or a relative number. While 0.5 is an absolute number, it may also be defined, that one percent of the number of keywords being comprised in the text corpus are selected. The selection metric itself may also be defined as a function of several other application scenarios of the method for providing at least one configuration data ontology module CDOM.

In the present embodiment as being depicted in FIG. 1, a threshold of 0.5 is applied for selection of concepts. Hence, the concepts C, D and E are selected. In a next step one identifies a third concept to which the selected concepts are related. In the present embodiment concepts C and D are directly related to concept A. In the present embodiment indirect relations, such as the relation between concept A and concept E over the intermediate node B are not considered. Hence, only the concepts C and D are considered in the following procedure, as both hold the same parent node A. The concept E is not considered for providing the configuration data ontology module CDOM.

As concepts C and D are comprised in the configuration data ontology module CDOM one relation between them is established as indicated in the present FIG. 1 by a dashed line. Hence, the configuration data ontology module CDOM has been generated according to an aspect of the method for providing at least one configuration data ontology module CDOM.

In further steps several other concepts which are not depicted in the present FIG. 1 may be chosen, in case the configuration data ontology CDO holds also other concepts. Hence, in further steps the configuration data ontology module CDOM is increased by adding further concepts. Thus, the configuration data ontology module CDOM may increase iteratively.

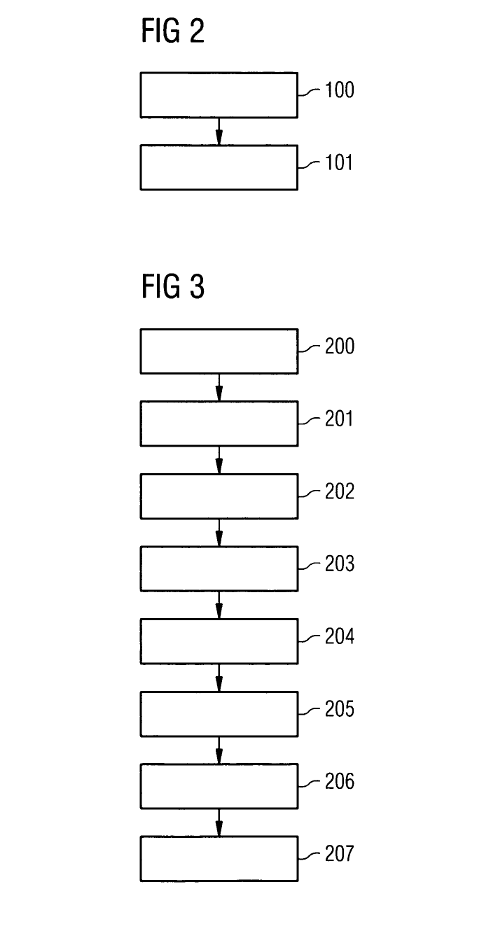

FIG. 2 shows a flow diagram according to an aspect of a method for providing at least one configuration data ontology module, which provides configuration data for at least one machine. The methods comprises the following steps:

In a first step 100 selecting a first concept and a second concept from a stored configuration data ontology is performed as a function of assigned concept weights, the stored configuration data ontology comprising a set of related concepts each related concept having an assigned concept weight.

In a further step 101 generating the configuration data ontology module is performed by automatically establishing a relation between the first selective concept and the second selective concept, wherein the first selected concept and the second selected concept are related to a third concept being comprised in the stored configuration data ontology.

The aforementioned steps may be performed iteratively and/or in a different order.

FIG. 3 shows a detailed flow diagram of an aspect of a method for providing at least one configuration data ontology module.

In a first step a first text corpus is created. The first text corpus may comprise several documents. The creation of the first text corpus in step 200 may for instance be performed by selection of domain specific websites, each website describing an aspect of the domain. The first text corpus being created in step 200 may for instance describe a specific part of a biomedical domain. Each of the documents contributing to the first text corpus describing for instance one type of cancer.

In a subsequent step 201 the first text corpus created in step 200 is provided, for instance via an interface and/or can be accessed by a query or a request.

In a subsequent step 202 the configuration data ontology is provided. In the present embodiment the configuration data ontology provides information about a biomedical device. The ontology provided in step 202 may for instance be FMA. The FMA holds biomedical information which allows a machine for identification of body regions and hence for configuring biomedical devices.

In a subsequent step 203 a second text corpus, a so called generic corpus, is provided. The second text corpus comprises documents of general interest and are hence not directed to a specific domain. Generally, a text corpus can be considered as a collection of a plurality of documents.

After having accomplished step 203 a first text corpus and a second text corpus are provided and furthermore a configuration data ontology is provided. The first text corpus, the second text corpus and the configuration data ontology serve as input for calculating concept weights. The calculation of concept weights is accomplished in a subsequent step 204.

For selection of concepts from the FMA ontology the statistically most relevant concepts are identified on the basis of chi-square scores calculated for nouns and adjectives. Configuration data ontology concepts that are single words and that occur in the first text corpus, correspond directly to the noun or adjective that the concept is build up of. For example, the noun “ear” from the corpus corresponds to the FMA ontology concept “Ear”. Thus, the statistically relevance of the ontology concept is the chi-square score of the corresponding noun or adjective.

In the case of multi-word ontology concepts, the statistical relevance is calculated on the basis of the chi-square score for each constituting noun and/or adjective in the concept name, summed and normalized over its length. Thus, the relevance value for “lymph node”, for example, is the summation of the chi-square scores for “lymph” and “node” divided by two. In order to take frequency into account, the summed relevance value is multiplied by the frequency of the term.

In step 205 the concepts are selected from the FMA ontology as a function of the assigned concept weights, the concept weights being assigned in step 204. The step 205 may comprise further substeps such as the receiving of a metric for selecting the concepts. In step 205 a threshold may be calculated as a function of the extent of the text corpus being provided in step 201 or as a function of the extent of the ontology being provided in step 202. Furthermore, the person skilled in the art appreciates other ways to calculate the threshold. The threshold may for instance be defined as a function of the desired extent of the configuration data ontology module. The calculated metric is applied for selection of the concepts of the ontology being provided in step 202.

Furthermore, selected concepts may be deleted in step 206. Therefore, at least one third concept is being identified, which is related to the selected concepts of step 205. The deletion of selected concepts in step 206 may comprise further substeps such as the calculation of a threshold, describing relatedness. The threshold for describing relatedness may for instance comprise the calculation of a number of a maximum of intermediate nodes on a path between two concepts. Hence, also indirect relatedness between concepts can be considered in the present method. One may for instance define that two concepts are related to a third concept if they are related indirectly by a maximum number of five intermediate concepts. In case one selected node in step 205 does not share a common third concept to which the concept itself and a further selected concept is related to, then the concept is deleted. The metrics according to which relatedness is calculated may also consider types or directions of relations. For instance the relations and the ontology provided in step 202 are of a certain type. For instance two concepts are related by a “is-parent” and a further pair of concepts are related by a “is-related” relation, then for instance only the “is-parent” relation is considered. Hence, two concepts are only related if they are connected by the number of the same relations. One may also define groups of relation types, which are considered for calculation relatedness.

In a final step 207 relations between the remaining selected concepts are inserted. Hence, a configuration data ontology module has been selected from the configuration data ontology.

The aforementioned steps may be performed iteratively and/or in a different order.

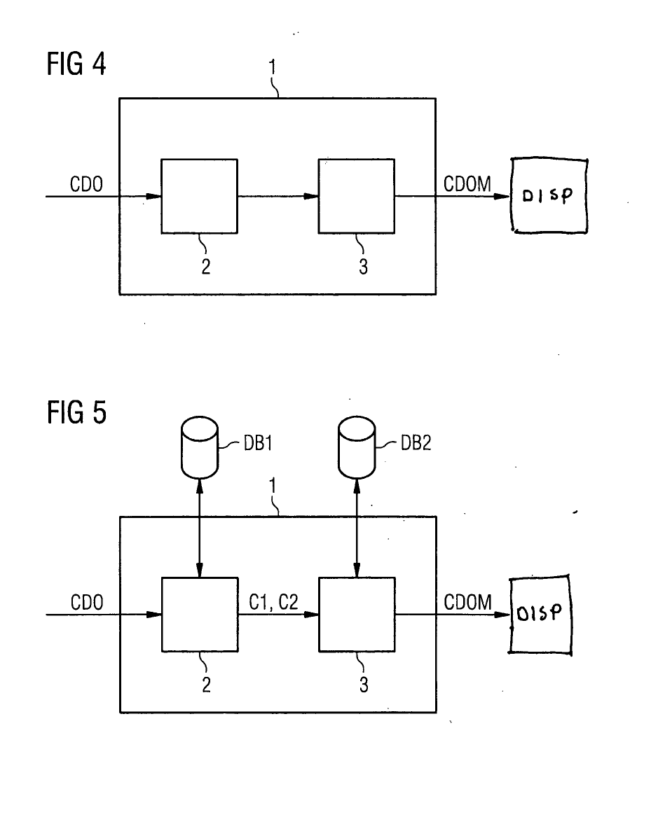

FIG. 4 shows a block diagram of an apparatus 1 for provision of at least one configuration data ontology module CDOM. The apparatus 1 comprises:

The device for selecting 2 a first concept and a second concept from a configuration data ontology CDO being stored in a storage device as a function of assigned concept weights, the stored configuration data ontology CDO comprising a set of related concepts each related concept having an assigned concept weight.

The apparatus 1 further comprises a device for generating 3 the configuration data ontology module CDOM by establishing a relation between the first selected concept and the second selected concept, wherein the first selected concept and the second selected concept are related to a third concept being comprised in the stored configuration data ontology CDO.

FIG. 5 shows a detailed block diagram of an apparatus 1 for provision of at least one configuration data ontology module CDOM and the first from the embodiment depicted in FIG. 4 as follows:

In the present embodiment the device for selecting 2 a first concept C1 and a second concept C2 communicates with a database DB1. The database DB1 stores a metric according to which the first concept C1 and the second concept C2 are selected. The database DB1 may also comprise a plurality of metrics according to which the first concept C1 and the second concept C2 can be selected. According to the application scenario the way of the selecting 2 may select also a metric suitable for selecting the concepts C1, C2 in dependence of an actual application scenario. In both FIGS. 4 and 5, the related concepts are displayed on a display DISP.

The selected first concept C1 and the selected second concept C2 is transmitted to the unit for generating 3 the configuration data ontology module CDOM. In the present embodiment the unit for generating 3 communicates with a database DB2 for receiving a metric for calculation of relatedness between pairwise concepts. The metric being stored in the database DB2 may be selected from a plurality of metrics according to an application scenario. For instance rules are selected, which state that two concepts are related in case an indirect relation of a maximum of ten intermediate nodes exists connecting both indirectly related nodes. In the further procedure only the first selected concept C1 and the second selected concept C2 are considered, which hold a relationship to a third concept according to the metric received and or selected from the database DB2.

The unit for selecting 2 and the unit for generating 3 may be formed by a processor, a microprocessor, a computer, a computer system, a central processing unit, an arithmetical calculation unit and/or a circuit.

The databases DB1, DB2 may be formed virtually or by any kind of storage device, such as a hard disc, a flash disc, a USB-stick, a floppy disc, a CD, a DVD, a blu ray disc, a band and/or a removable storage medium.

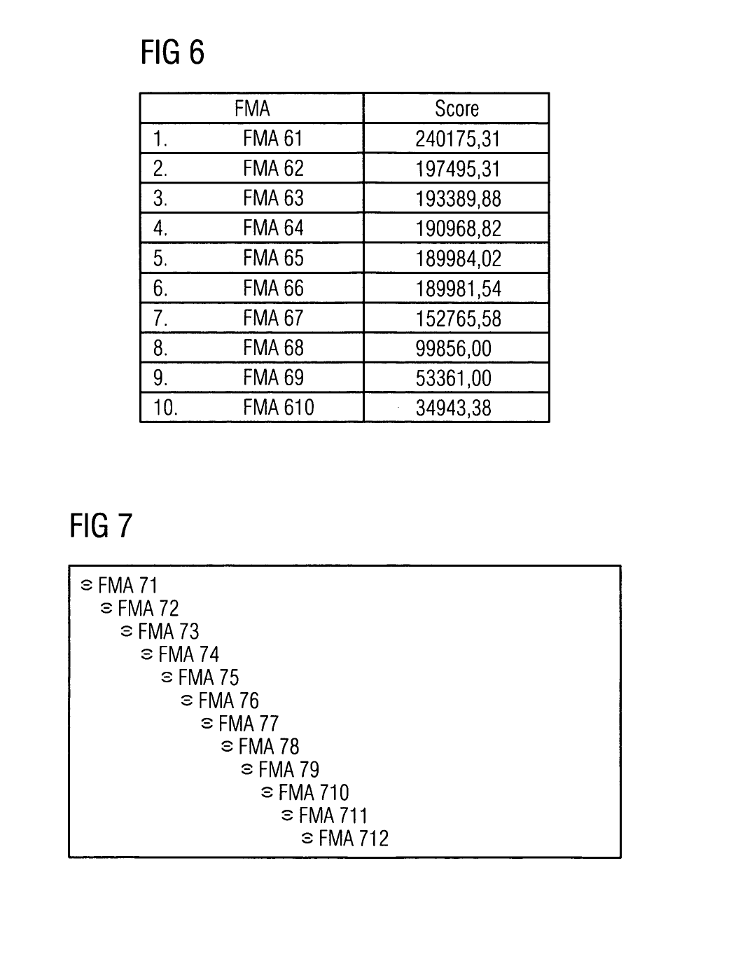

FIG. 6 shows a table assigning each concept a concept weight. In the present embodiment the concepts of the reference signs hold the following semantics:

Reference signs of FIG. 6

| | |
|---|---|
| FMA61 | Normal cell |
| FMA62 | Cell morphology |
| FMA63 | Stem cell |
| FMA64 | Plasma cell |
| FMA65 | Cell membrane |
| FMA66 | Cell surface |
| FMA67 | Lymphoid tissue |
| FMA68 | Lymph |
| FMA69 | Immunoglobulin |
| FMA610 | Inguinal lymph node |

In the present embodiment the FMA ontology has been searched for the most relevant FMA concepts as regards a further biomedical text corpus vs. those in a generic corpus. In the present embodiment the concept weights are named as “score”, each of the score values indicating a number of relevance for each concept as regards the biomedical text corpus. The concept “normal cell” FMA61 is of high relevance as regards the biomedical text corpus and is therefore scored with a concept weight of 240175,31. As “normal cell” FMA61 is of highest relevance, it has the highest score and is therefore ranked as a top most concept.

In the analysis represented in FIGS. 7, 8 and 9 the concepts “inguinal lymph node”, “plasma cell” and “plasma membrane” have been examined.

In the present embodiment the concepts of the reference signs hold the following semantics:

Reference signs of FIG. 7

| | |
|---|---|
| FMA71 | Foundational Model of Anatomy |
| FMA73 | Ancestors |
| FMA74 | Foundational Model of Anatomy |
| FMA75 | Anatomical entity |
| FMA76 | Physical anatomical entity |
| FMA77 | Material anatomical entity |
| FMA78 | Anatomical structure |
| FMA79 | Cardinal organ part |
| FMA710 | Organ component |
| FMA711 | Lymph node |
| FMA712 | Lymph node of lower limb |
| FMA72 | Inguinal lymph node |

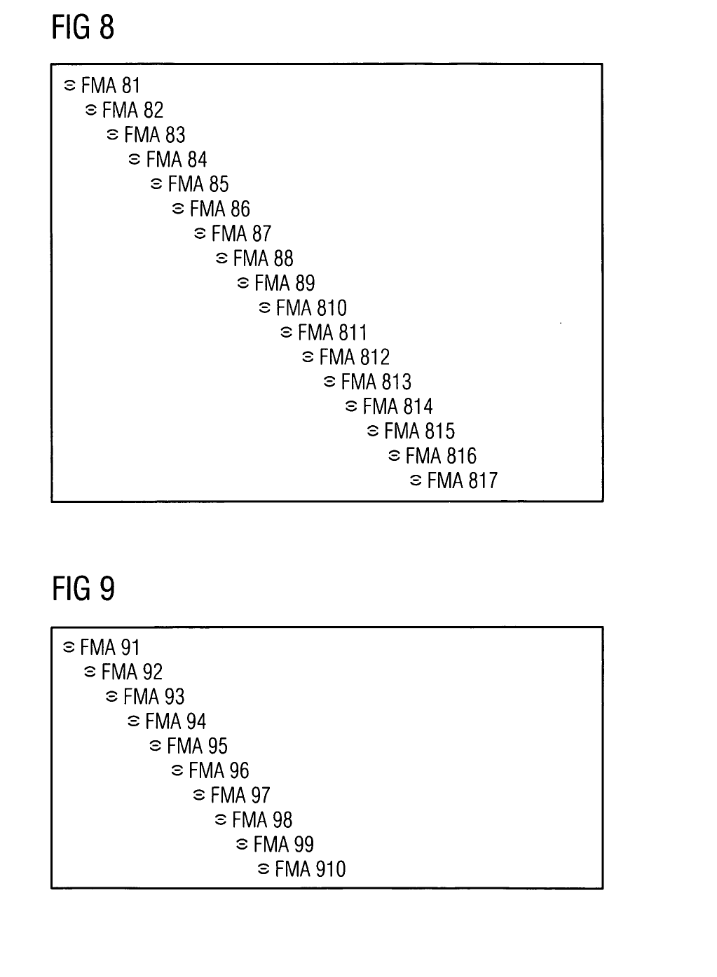

Reference signs of FIG. 8

| | |
|---|---|
| FMA81 | Foundational Model of Anatomy |
| FMA83 | Ancestors |
| FMA84 | Foundational Model of Anatomy |
| FMA85 | Anatomical entity |
| FMA86 | Physical anatomical entity |
| FMA87 | Material anatomical entity |
| FMA88 | Anatomical structure |
| FMA89 | Cell |
| FMA810 | Nucleated cell |
| FMA811 | Diploid nucleated cell |
| FMA812 | Semantic cell |
| FMA813 | Hemal cell |
| FMA814 | Differentiated hemal cell |
| FMA815 | Leukocyte |
| FMA816 | Nongranular leukocyte |
| FMA817 | Lymphocyte |
| FMA82 | Plasma cell |

Reference signs of FIG. 9

| | |
|---|---|
| FMA91 | Foundational Model of Anatomy |
| FMA93 | Ancestors |
| FMA94 | Foundational Model of Anatomy |
| FMA95 | Anatomical entity |
| FMA96 | Physical anatomical entity |
| FMA97 | Material anatomical entity |
| FMA98 | Anatomical structure |
| FMA99 | Cardinal cell part |
| FMA910 | Cell component |
| FMA92 | Plasma membrane |

In FIG. 8 the hierarchical context of “plasma cell” FMA82 in the FMA ontology is represented. In FIG. 9 the hierarchical context of “plasma membrane” FMA92 is represented. Hence, FIGS. 7, 8 and 9 show concepts and their relations of the FMA ontology. This is required for determining whether two concepts are related to a third concept. As can be seen in FIG. 7 the concept “inguinal lymph node” FMA72 has seven intermediate concepts to a concept “anatomical entity” FMA75. Hence, the concept “inguinal lymph node” FMA72 is indirectly related over seven intermediate concepts to the concept “anatomical entity” FMA75. The further intermediate concepts are also defined for the concept “plasma cell” FMA82 in FIG. 8 as well as for the concept “plasma membrane” FMA92 in FIG. 9. It can be seen, that the number of intermediate nodes between “plasma cell” FMA82 and “anatomical entity” FMA85 is twelve and the number of intermediate nodes between the concept “plasma membrane” FMA92 and “anatomical entity” FMA95 is five. For calculation of relatedness between concepts a metric stating the maximal number of intermediate concepts has to be applied.

In the present embodiment the threshold for a maximum number of intermediated nodes or concepts respectively is ten. Hence, according to the present embodiment the concept “inguinal lymph node” and “plasma membrane” are considered for creation of the configuration data ontology module as they both have intermediate nodes of a number less than ten. As the “plasma cell” is related to the “anatomical entity” with the number of intermediate nodes of 12, it is not considered in the generation of the configuration data ontology. Hence, only the concepts “inguinal lymph node” and “plasma cell” are part of the configuration data ontology module and are therefore connected with a relationship. Both nodes, “inguinal lymph node” and “plasma membrane” together with the established relation between them is provided as the configuration data ontology module.

The embodiments can be implemented in computing hardware (computing apparatus) and/or software, such as (in a non-limiting example) any computer that can store, retrieve, process and/or output data and/or communicate with other computers. The processes can also be distributed via, for example, downloading over a network such as the Internet. The results produced can be output to a display device, printer, readily accessible memory or another computer on a network. A program/software implementing the embodiments may be recorded on computer-readable media comprising computer-readable recording media. The program/software implementing the embodiments may also be transmitted over a transmission communication media such as a carrier wave. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

What is claimed is:

1. A method for providing a configuration data ontology module, which provides configuration data for a machine, comprising:
selecting a first concept and a second concept from a database storing a configuration data ontology, the first and second concepts being selected as a function of assigned concept weights, the configuration data ontology comprising a set of related concepts, each concept having an assigned concept weight;
generating the configuration data ontology module by automatically establishing a relation between the first concept and the second concept, the first concept and the second concept being related if the first concept is related to a third concept in the configuration data ontology and the second concept is also related to the third concept; and
displaying the configuration data ontology module.

2. The method according to claim 1, wherein selecting the first concept and the second concept is performed as a function of a weight threshold.

3. The method according to claim 2, wherein the weight threshold defines a lower limit for assigned concept weights of the first concept and of the second concept.

4. The method according to claim 3, wherein
the ontology relates to word relationships within a text corpus, and
the weight threshold is selected from the group consisting of an absolute weight threshold, a weight threshold defined as a function of the number of concepts of the ontology, a weight threshold defined as a function of the number of concepts of the ontology module and a weight threshold defined as a function of the number of words of the text corpus.

5. The method according to claim 4, wherein the related concepts are related by at least one relation selected from the group consisting of a directed relation, an undirected relation, a relation of a prescribed type and a relation indicating a hierarchy.

6. The method according to claim 5, wherein the first concept and the second concept are related to the third concept if a first relation between the first concept and the third concept and a second relation between the second concept and the third concept are in an identical relation category.

7. The method according to claim 6, wherein the first concept and the second concept are each related to the third concept through at least one intermediate concept.

8. The method according to claim 7, wherein an upper limit a maximum permissible number defines of intermediate concepts under which pair-wise concepts are related.

9. The method according to claim 8, wherein the machine for which the configuration data is provided, is at least one device selected from the group consisting of a medical device, a production device, a data processing system and an image processing device.

10. The method according to claim 9, wherein each concept is at least one data element selected from the group consisting of a term, an attribute, a variable, a value and a keyword.

11. An apparatus to provide configuration data ontology module for a machine, comprising:
means for selecting a first concept and a second concept from a database storing a configuration data ontology, the first and second concepts being selected as a function of assigned concept weights, the configuration data ontology comprising a set of related concepts, each concept having an assigned concept weight;
means for generating the configuration data ontology module by establishing a relation between the first concept and the second concept, the first concept and the second concept being related if the first concept is related to a third concept in the configuration data ontology and the second concept is also related to the third concept; and
display means for displaying the configuration data ontology module.

12. A computer to provide a configuration data ontology module, comprising:
a first calculation device to select a first concept and a second concept from a configuration data ontology stored in a database, the first and second concepts being selected as a function of assigned concept weights, the configuration data ontology comprising a set of related concepts, each concept having an assigned concept weight;
a second calculation device to generate the configuration data ontology module by establishing a relation between the first concept and the second concept, the first concept and the second concept being related if the first concept is related to a third concept in the configuration data ontology and the second concept is also related to the third concept; and
a display device to display the configuration data ontology module.

13. The computer according to claim 12, wherein the first calculation device and the second calculation device are formed by a single calculation device.

14. A computer readable storage medium storing a program to control a computer to perform a method for providing at least one configuration data ontology module, which provides configuration data for a machine, the method comprising:
selecting a first concept and a second concept from a database storing configuration data ontology as a function of assigned concept weights, the configuration data ontology comprising a set of related concepts, each concept having an assigned concept weight;
generating the configuration data ontology module by automatically establishing a relation between the first concept and the second concept, the first concept and the second concept being related if the first concept is related to a third concept in the configuration data ontology and the second concept is also related to the third concept; and
displaying the configuration data ontology module.
